(19) United States
(12) Patent Application Publication
(10) Pub. No.: US 2026/0296045 A1
(43) Pub. Date: Oct. 1, 2026

(54) LIQUID STORAGE TANK, LIQUID CIRCULATION DEVICE, RECORDING APPARATUS INCLUDING LIQUID CIRCULATION DEVICE, AND LIQUID STORAGE TANK GROUP

(71) Applicant: KYOCERA CORPORATION, Kyoto-shi, Kyoto (JP)

(72) Inventor: Daisuke ETO, Nishi-ku, Osaka-shi, Osaka (JP)

(21) Appl. No.: 19/480,367

(22) PCT Filed: May 21, 2024
(86) PCT No.: PCT/JP2024/018630

§ 371 Date: Oct. 31, 2025

(30) Foreign Application Priority Data
May 24, 2023 (JP) 2023-085728

(51) Int. Cl. B41J 2/18; B41J 2/175; B41J 2/195; B41J 2/20; G01F 23/26

(52) U.S. Cl. CPC B41J 2/18; B41J 2/17566; B41J 2/195; B41J 2/20; G01F 23/26

(57) ABSTRACT

A liquid storage tank includes a tank body that stores a liquid and a bubble detector that detects bubbles of the liquid above a level of the liquid in the tank body. The tank body communicates with a liquid functional component configured to perform a predetermined function for the liquid. The tank body has a negative pressure with respect to the liquid functional component.

### TECHNICAL FIELD

The present invention relates to a liquid storage tank, a liquid circulation device, a recording apparatus including the liquid circulation device, and a liquid storage tank group.

### BACKGROUND OF INVENTION

Patent Literature 1 describes an inkjet recording apparatus including an assembly that circulates ink. With this technique, the inkjet recording apparatus includes a tank that stores ink, a recording head that ejects ink supplied from the tank, a supply channel that supplies ink from the tank to the recording head, a collection channel that collects ink from the recording head to the tank, and a pump.

### CITATION LIST

### Patent Literature

Patent Literature 1: Japanese Unexamined Patent Application Publication No. 2022-51952

### SUMMARY

In one aspect of the present disclosure, a liquid storage tank includes a tank body and a bubble detector. The tank body stores a liquid. The bubble detector detects bubbles of the liquid above a level of the liquid in the tank body. The tank body communicates with a liquid functional component configured to perform a predetermined function for the liquid. The tank body has a negative pressure with respect to the liquid functional component.

In another aspect of the present disclosure, a liquid circulation device includes the above liquid storage tank, the above liquid functional component, a supply tank, and a circulation channel. The supply tank communicates with the liquid functional component upstream from the liquid functional component. The circulation channel extends from the supply tank and back to the supply tank through the liquid functional component and the liquid storage tank. The liquid storage tank has a negative pressure with respect to the supply tank.

In still another aspect of the present disclosure, a recording apparatus includes the above liquid circulation device and a medium support. The medium support supports an object to cause the object to face an ejection head. The recording apparatus is configured to perform recording on the object with the liquid ejected from the ejection head.

In still another aspect of the present disclosure, a liquid storage tank group includes a plurality of the above liquid storage tanks. The plurality of liquid storage tanks includes a first liquid storage tank that stores a pretreatment liquid and a second liquid storage tank that stores ink or a post-treatment liquid. The bubble detector in the first liquid storage tank has a lower sensitivity than the bubble detector in the second liquid storage tank.

### BRIEF DESCRIPTION OF THE DRAWINGS

FIG. 1 is a perspective view of a recording apparatus according to one embodiment of the present disclosure, illustrating its overall structure.

FIG. 2 is a schematic cross-sectional view taken along line II-II in FIG. 1.

FIG. 3 is an enlarged perspective view of a carriage illustrated in FIG. 1.

FIG. 4 is a schematic diagram illustrating a flow of ink near ink heads in one embodiment of the present disclosure.

FIG. 5 is a schematic diagram of a supply subtank and a collection subtank according to one embodiment of the present disclosure.

FIG. 6 is a perspective view of a tank unit according to one embodiment of the present disclosure.

FIG. 7 is a perspective view of a tank unit according to one embodiment of the present disclosure as viewed in a direction opposite to the direction in FIG. 6.

FIG. 8 is a front perspective view of a tank unit according to one embodiment of the present disclosure.

FIG. 9 is a side cross-sectional view of a collection subtank according to an embodiment, illustrating a liquid in its inside.

### DESCRIPTION OF EMBODIMENTS

A recording apparatus according to one embodiment of the present disclosure will now be described below with reference to the drawings. In one or more embodiments below, an inkjet printer including an ink head that ejects ink for image formation onto a wide and long recording medium will be described as a specific example of the recording apparatus.

The inkjet printer may be used for digital textile printing to print images such as letters or patterns by inkjet printing on a recording medium including a textile such as woven fabric or knitted fabric. In one or more embodiments of the present disclosure, the recording apparatus is also used for printing various images on a recording medium such as a paper sheet or a resin sheet.

### Overall Structure of Inkjet Printer

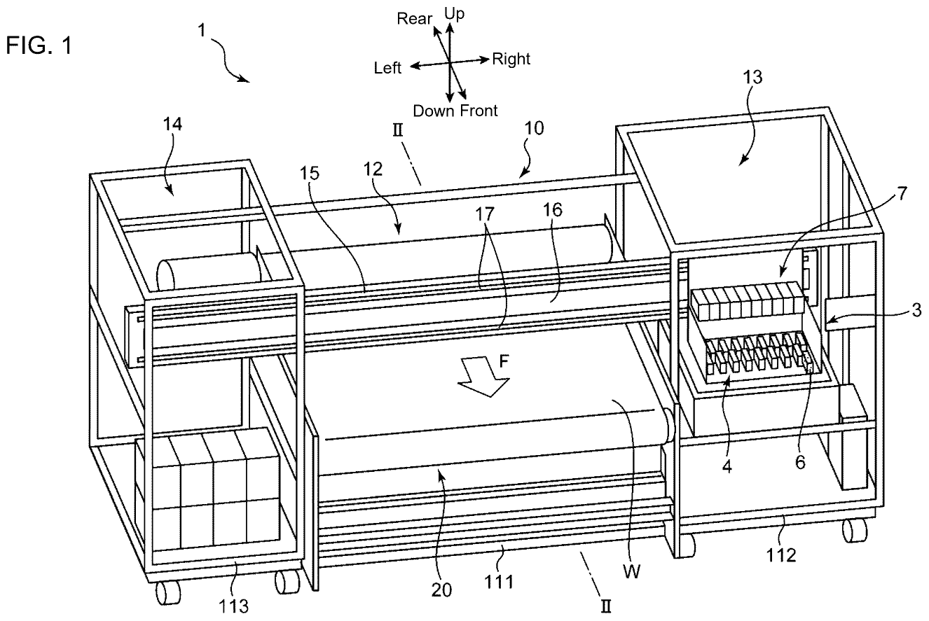

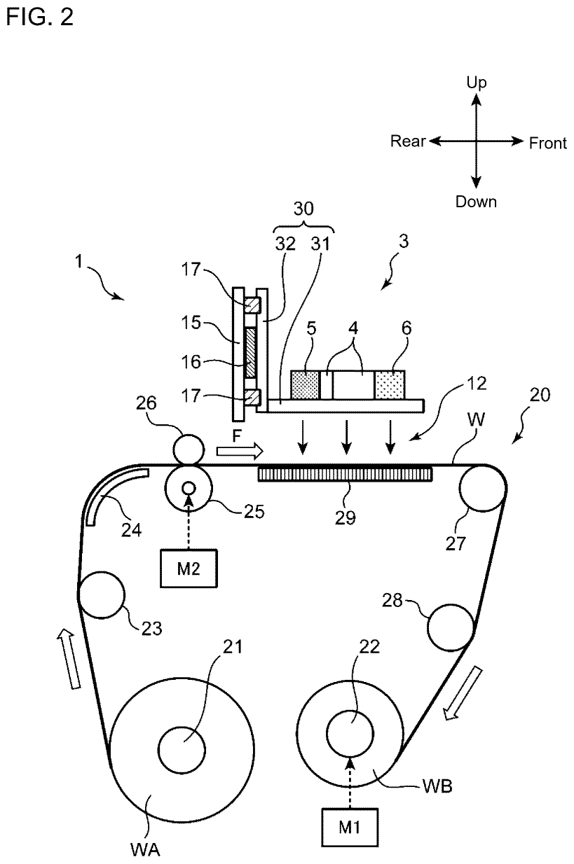

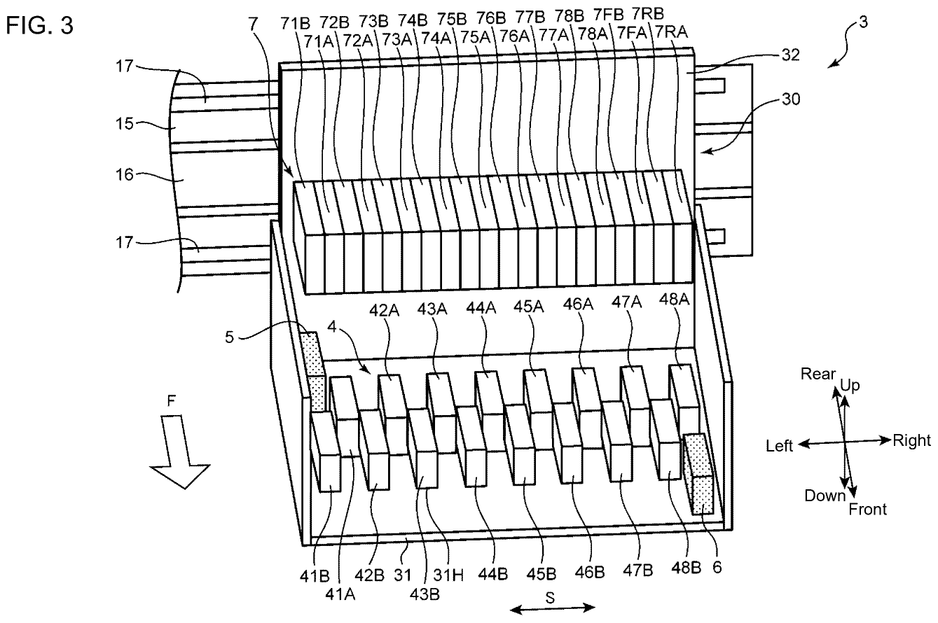

FIG. 1 is a perspective view of an inkjet printer 1 according to one embodiment of the present disclosure, illustrating its overall structure. FIG. 2 is a schematic cross-sectional view taken along line II-II in FIG. 1. The inkjet printer 1 is a printer that prints an image on a wide and long workpiece W (a recording medium or an object) by inkjet printing. An example workpiece W is several meters wide. The printer 1 includes an apparatus frame 10, and a workpiece feeder 20 and a carriage 3 incorporated in the apparatus frame 10. Note that, in the present embodiment, a lateral direction is a main scanning direction S (FIG. 3) in printing on the workpiece W, and a direction from rear to front is a subscanning direction (a feed direction F of the workpiece W intersecting with the main scanning direction S).

The apparatus frame 10 is a frame on which various components of the inkjet printer 1 are mounted. The workpiece feeder 20 is an assembly that intermittently feeds (transports) the workpiece W to allow the workpiece W to move in the feed direction F from rear to front in a printing area in which an inkjet printing process is performed. The carriage 3 carries an ink head 4, a pretreatment liquid head 5, a post-treatment liquid head 6, and a subtank 7, and reciprocates in the main scanning direction S (lateral direction) intersecting with the feed direction F of the workpiece W during the inkjet printing process.

The apparatus frame 10 includes a center frame 111, a right frame 112, and a left frame 113. The center frame 111 is a frame on which various components of the inkjet printer 1 are mounted and has a lateral width corresponding to the workpiece feeder 20. The right frame 112 stands on the right of the center frame 111, and the left frame 113 stands on the left of the center frame 111. A printing area 12 in which a printing process is performed on the workpiece W is defined between the right frame 112 and the left frame 113.

The right frame 112 defines a maintenance area 13. The maintenance area 13 is an area into which the carriage 3 is retracted when the printing process is not performed. In the maintenance area 13, nozzles (ejection orifices) of the ink head 4, the pretreatment liquid head 5, and the post-treatment liquid head 6 are, for example, cleaned or purged, or each of the nozzles is capped. The left frame 113 defines a turn-back area 14 for the carriage 3. The turn-back area 14 is an area for the carriage 3 that has performed main scanning on the printing area 12 from right to left in the printing process to enter temporarily before performing main scanning in the reverse direction.

The apparatus frame 10 receives, on its upper portion, a carriage guide 15 for guiding the carriage 3 to reciprocate in the lateral direction. The carriage guide 15 is a flat plate elongated in the lateral direction and is located above the workpiece feeder 20. The carriage guide 15 receives a timing belt 16 rotatable in the lateral direction (main scanning direction). The timing belt 16 is an endless belt that is driven to rotate in the left direction or the right direction.

The carriage guide 15 includes a pair of upper and lower guide rails 17 holding the carriage 3 in a manner reciprocable in the main scanning direction S. The pair of guide rails 17 extend parallel to each other in the lateral direction. The carriage 3 is engaged with the guide rails 17. The carriage 3 is fixed to the timing belt 16. The carriage 3, while being guided by the guide rails 17, moves in the left direction or the right direction along the carriage guide 15 as the timing belt 16 rotates in the left direction or the right direction.

Referring mainly to FIG. 2, the workpiece feeder 20 includes a feed roller 21 that unwinds the workpiece W before printing, and a take-up roller 22 that winds the workpiece W after printing. The feed roller 21 is located in a lower rear portion of the apparatus frame 10. The feed roller 21 is a winding shaft of a feed roll WA as a wound roll of the workpiece W before printing. The take-up roller 22 is located in a lower front portion of the apparatus frame 10. The take-up roll is a winding shaft of a take-up roll WB as a wound roll of the workpiece W after the printing process. The take-up roller 22 includes a first motor M1 that rotates the take-up roller 22 about its axis to wind the workpiece W.

A path extending through the printing area 12 between the feed roller 21 and the take-up roller 22 is a feed path of the workpiece W. This feed path includes, in the order from upstream, a first tension roller 23, a workpiece guide 24, a transport roller 25 and a pinch roller 26, a turn roller 27, and a second tension roller 28. The first tension roller 23 applies a predetermined tension to the workpiece W upstream from the transport roller 25. The workpiece guide 24 redirects the workpiece W from upward to frontward and feeds the workpiece W into the printing area 12.

The transport roller 25 generates a feed force for feeding the workpiece W intermittently in the printing area 12. The transport roller 25, which is driven by a second motor M2, rotates about its axis and intermittently feeds the workpiece W frontward (in the predetermined feed direction F) to allow the workpiece W to pass through the printing area 12 (image formation position) facing the carriage 3. The pinch roller 26 faces the transport roller 25 from above and forms a feed nip with the transport roller 25.

The turn roller 27 redirects the workpiece W that has passed through the printing area 12 from frontward to downward, and guides the workpiece W after the printing process to the take-up roller 22. The second tension roller 28 applies a predetermined tension to the workpiece W downstream from the transport roller 25. A platen 29 is located below the feed path of the workpiece W in the printing area 12.

The carriage 3 reciprocates, while being held by the guide rails 17 in a cantilevered manner, in the main scanning direction S (the lateral direction in the present embodiment) intersecting with (in the present embodiment, perpendicular to) the feed direction F. The carriage 3 includes a carriage frame 30 as well as the ink head 4, the pretreatment liquid head 5, the post-treatment liquid head 6, and the subtank 7 mounted on the carriage frame 30 (FIG. 3). The carriage frame 30 includes a head support frame 31 and a back frame 32.

The head support frame 31 is a horizontal plate holding the heads 4 to 6 described above. The back frame 32 is a vertical plate extending upward from a rear edge of the head support frame 31. As described above, the timing belt 16 is fixed to the back frame 32. The guide rails 17 are engaged with the back frame 32. In other words, the back frame 32 is an engaging portion held by the guide rails 17 in a cantilevered manner in the present embodiment. The head support frame 31 is a horizontal plate including a rear end portion held by the guide rails 17 in a cantilevered manner with the engaging portion.

Note that being held in a cantilevered manner refers to a state in which the engaging portion (back frame 32) in the carriage 3 held by the guide rails 17 as holding members is located upstream or downstream alone from the middle of the carriage 3 in the feed direction F, with no other engaging portion in an area opposite to the area including the engaging portion. The engaging portion may also be located outside an area including the ink head 4 and the treatment heads in the feed direction F. In other words, the engaging portion may be located upstream or downstream alone from the area including the ink head 4 and the treatment heads in the feed direction F.

### Details of Carriage

The carriage 3 will be described further. FIG. 3 is an enlarged perspective view of the carriage 3 illustrated in FIG. 1. In FIG. 3, the feed direction F (subscanning direction) of the workpiece W and the main scanning direction S in which the carriage 3 moves are illustrated. In the example illustrated in FIG. 3, the carriage 3 carries multiple ink heads 4 that eject ink for image formation onto the workpiece W, the pretreatment liquid head 5 and the post-treatment liquid head 6 that eject noncolor-developing treatment liquids, and multiple subtanks 7 that supply the ink and the treatment liquids to the heads 4 to 6.

Each of the ink heads 4 includes many nozzles (ink ejection orifices) and an ink channel that guides ink to the nozzles. The nozzles eject ink droplets by, for example, piezoelectric ejection using piezoelectric elements or thermal ejection using heating elements. Examples of the ink include water-based pigment ink containing a water-based solvent, a pigment, and a bonding resin (binder). In the present embodiment, the multiple ink heads 4 can eject eight colors of ink. The ink heads 4 are mounted on the head support frame 31 in the carriage 3 (FIG. 2) in two arrays in the main scanning direction S. Two ink heads 4 are used for each of the colors.

More specifically, the ink heads 4 include a first upstream ink head 41A and a first downstream ink head 41B. These ink heads 4 eject yellow ink. The ink heads 4 also include a second upstream ink head 42A and a second downstream ink head 42B. These ink heads 4 eject magenta ink. In the same or a similar manner, two ink heads 4 that eject the same color of ink are arranged in a manner displaced from each other in the feed direction F and the main scanning direction S as illustrated in FIG. 3. With these two ink heads 4 being paired, a total of eight pairs of ink heads 4 (41A to 48A and 41B to 48B) eject different colors of ink.

The pretreatment liquid head 5 and the post-treatment liquid head 6 are at different positions from the ink heads 4 in the feed direction F. The pretreatment liquid head 5 is upstream from the ink heads 4 in the feed direction F. In the example illustrated in FIG. 3, a single pretreatment liquid head 5 is located adjacent to the left end of an array of ink heads 4. In the same or a similar manner, the post-treatment liquid head 6 is downstream from the ink heads 4 in the feed direction F. In the example illustrated in FIG. 3, a single post-treatment liquid head 6 is located at the right end of an array of ink heads 4. In another embodiment, multiple pretreatment liquid heads 5 or multiple post-treatment liquid heads 6 may be arranged. Although the carriage 3 may carry at least one pretreatment liquid head 5 and at least one post-treatment liquid head 6, the carriage 3 may carry none of the pretreatment liquid head 5 or the post-treatment liquid head 6 in another embodiment.

Note that a series of heads including the ink heads 4, the pretreatment liquid head 5, and the post-treatment liquid head 6 aligned in the main scanning direction S is referred to as an array of heads, or simply an array. A series of heads including the ink heads 4, the pretreatment liquid head 5, and the post-treatment liquid head 6 aligned in the feed direction F is referred to as a line of heads, or simply a line.

The pretreatment liquid head 5 ejects a pretreatment liquid for a predetermined pretreatment of the workpiece W. The pretreatment liquid is ejected from the pretreatment liquid head 5 to an area of the workpiece W on which no ink has been ejected from the ink heads 4. The pretreatment liquid is a noncolor-developing treatment liquid that develops no color on the workpiece W, and improves, for example, fixation of ink on the workpiece W or facilitates agglomeration of ink pigments. Examples of the pretreatment liquid include a treatment liquid of a solvent containing a bonding resin and a treatment liquid of a solvent containing a positively charged cationic resin.

The post-treatment liquid head 6 ejects a post-treatment liquid for a predetermined post-treatment of the workpiece W with ink applied. The post-treatment liquid is ejected from the post-treatment liquid head 6 to an area of the workpiece W on which ink has been ejected from the ink heads 4. The post-treatment liquid is also a noncolor-developing treatment liquid that develops no color on the workpiece W. The post-treatment liquid improves the fixation and the toughness (durability against rubbing or scratching) of an ink image printed on the workpiece W by the ink heads 4. Examples of the post-treatment liquid include a silicone treatment liquid. Note that the post-treatment liquid is different from the pretreatment liquid. More specifically, the post-treatment liquid and the pretreatment liquid contain different components.

The noncolor-developing treatment liquid refers to a liquid that is not perceptible as having developed a color to the naked eye when printed on a recording medium alone. The color includes colors with zero saturation, such as black, white, and gray. Although the noncolor-developing treatment liquid is basically a transparent liquid, a liter of treatment liquid in a liquid state may appear, for example, slightly white or another color. Such a faint color is not perceptible as having developed a color to the naked eye when printed on a recording medium alone. Note that, although a type of treatment liquid printed alone on a recording medium may cause a change such as adding gloss to the recording medium, such a change is not referred to as developing a color.

In the present embodiment, the pretreatment liquid and the post-treatment liquid may be ejected across substantially the entire surface of the workpiece W, or may be selectively ejected based on an image to be printed in the same manner as or in a similar manner to the ink.

Selective ejection of the pretreatment liquid and the post-treatment liquid will now be described. As described above, the pretreatment liquid, the ink, and the post-treatment liquid are ejected in this order on an area of the workpiece W on which colors are printed based on an image. In this case, the ink may have one color or multiple colors. For an area on which no color is printed, or in other words, an area on which no ink is ejected, no pretreatment liquid or no post-treatment liquid is basically ejected. Note that, to adjust the quality of an image to be printed or the texture of the workpiece W, areas on which the pretreatment liquid and the post-treatment liquid are selectively ejected may be partially different from an area on which ink is selectively ejected.

As illustrated in FIG. 3, the head support frame 31 includes openings 31H at positions of the heads. The head support frame 31 receives the ink heads 4, the pretreatment liquid head 5, and the post-treatment liquid head 6 fitted into the respective openings 31H. The nozzles on the lower end face of each of the heads 4, 5, and 6 are exposed through the corresponding opening 31H.

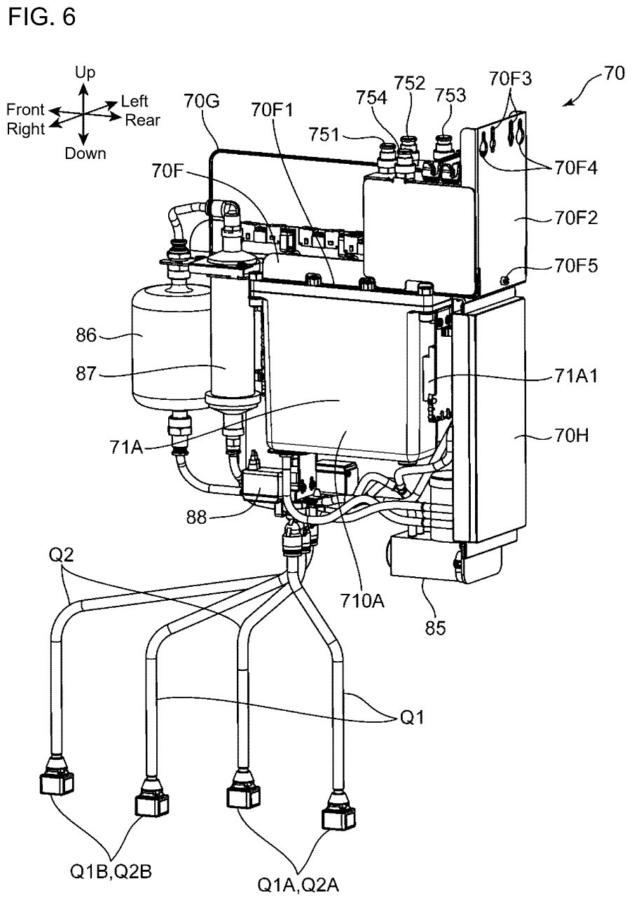

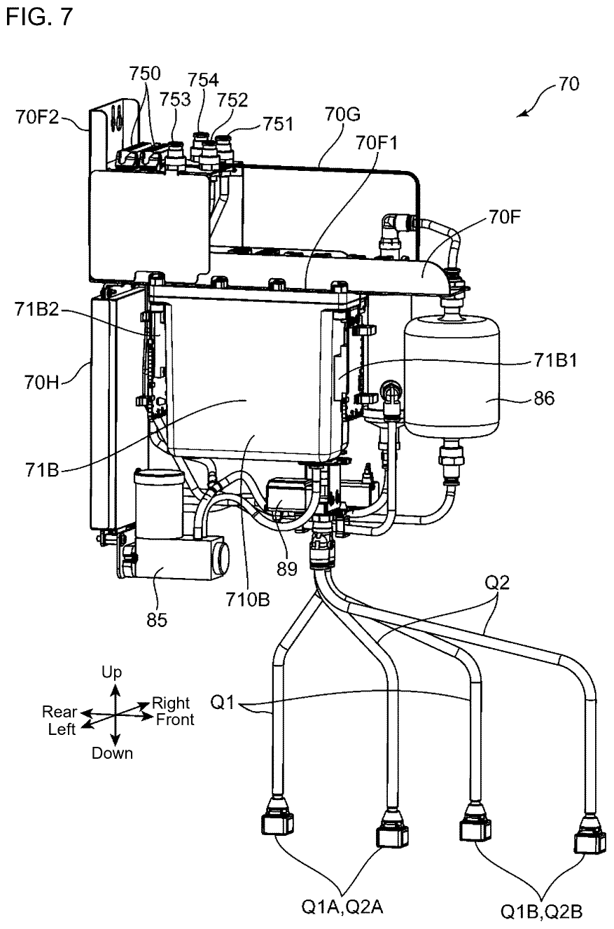

The multiple subtanks 7 are supported by the carriage 3 with a frame 70F (FIGS. 6 and 7, described later) above the heads 4, 5, and 6. The multiple subtanks 7 correspond to the respective heads 4, 5, and 6. Each of the subtanks 7 receives the ink or the treatment liquid from a main tank 91 and an intermediate tank 94 (described later) storing the ink or the treatment liquid, and supplies the ink or the treatment liquid to the corresponding head 4, 5, or 6. Each of the subtanks 7 is connected to the corresponding head 4, 5, or 6 with a pipe (not illustrated in FIG. 3).

The multiple subtanks 7 include a first supply subtank 71A to an eighth supply subtank 78A, a pretreatment supply subtank 7FA, and a post-treatment supply subtank 7RA. The multiple subtanks 7 also include a first collection subtank 71B to an eighth collection subtank 78B, a pretreatment collection subtank 7FB, and a post-treatment collection subtank 7RB. Note that the supply subtanks and the collection subtanks are illustrated as simple boxes for ease of explanation in FIG. 3. Their actual structures and shapes will be described in detail later.

The first supply subtank 71A (supply tank) and the first collection subtank 71B (liquid storage tank) store yellow ink containing a pigment. The first supply subtank 71A stores the yellow ink to be supplied to the first upstream ink head 41A and the first downstream ink head 41B (each referred to as an ejection head or a liquid functional component). The first collection subtank 71B stores the yellow ink collected from the first upstream ink head 41A and the first downstream ink head 41B. Note that part of the yellow ink is ejected from the first upstream ink head 41A and the first downstream ink head 41B onto the workpiece W as described above. In the same or a similar manner, the second supply subtank 72A stores magenta ink to be supplied to the second upstream ink head 42A and the second downstream ink head 42B. The second collection subtank 72B stores the magenta ink collected from the second upstream ink head 42A and the second downstream ink head 42B. The remaining third to eighth subtanks also have the same or similar structures and function as described above.

The pretreatment supply subtank 7FA stores the pretreatment liquid to be supplied to the pretreatment liquid head 5. The pretreatment collection subtank 7FB stores the pretreatment liquid collected from the pretreatment liquid head 5.

The post-treatment supply subtank 7RA stores the post-treatment liquid to be supplied to the post-treatment liquid head 6. The post-treatment collection subtank 7RB stores the post-treatment liquid collected from the post-treatment liquid head 6.

In the present embodiment, as described above, the inkjet printer 1 is an all-in-one printer including three types of heads, or the ink heads 4, the pretreatment liquid head 5, and the post-treatment liquid head 6, mounted on the single carriage 3. The inkjet printer 1 can integrally perform the pretreatment liquid ejection and the post-treatment liquid ejection in an inkjet printing process on a textile in, for example, digital textile printing. This can simplify the textile printing process and reduce the size of textile printing apparatuses. With the subtanks 7 mounted on the carriage 3, the size of the apparatuses can be further reduced.

Note that the inkjet printer 1 according to the present embodiment performs the printing process on the workpiece W by serial printing. More specifically, for a wide workpiece W, the workpiece W cannot undergo printing while being fed continuously. With serial printing, the carriage 3 carrying the ink heads 4 of the respective colors repeatedly reciprocates in the main scanning direction S while the workpiece W is intermittently fed in the feed direction F.

More specifically, the carriage 3 moving in an outgoing direction, which is one direction of the main scanning direction S, prints a strip image. During the main scanning in the outgoing direction, the feed of the workpiece W is stopped. The workpiece W on which the strip image has been printed is then fed forward in the feed direction F by a predetermined pitch. During the feed, the carriage 3 stays in the turn-back area 14 at the left end. After the workpiece W is fed forward, the carriage 3 turns back in a return direction opposite to the outgoing direction, as the timing belt 16 rotates in the reverse direction. The workpiece W is stopped. The carriage 3 then moves in the return direction and prints a subsequent strip image upstream from the strip image described above. The same or similar movement is repeated subsequently.

### Circulation Channel of Ink and Treatment Liquids

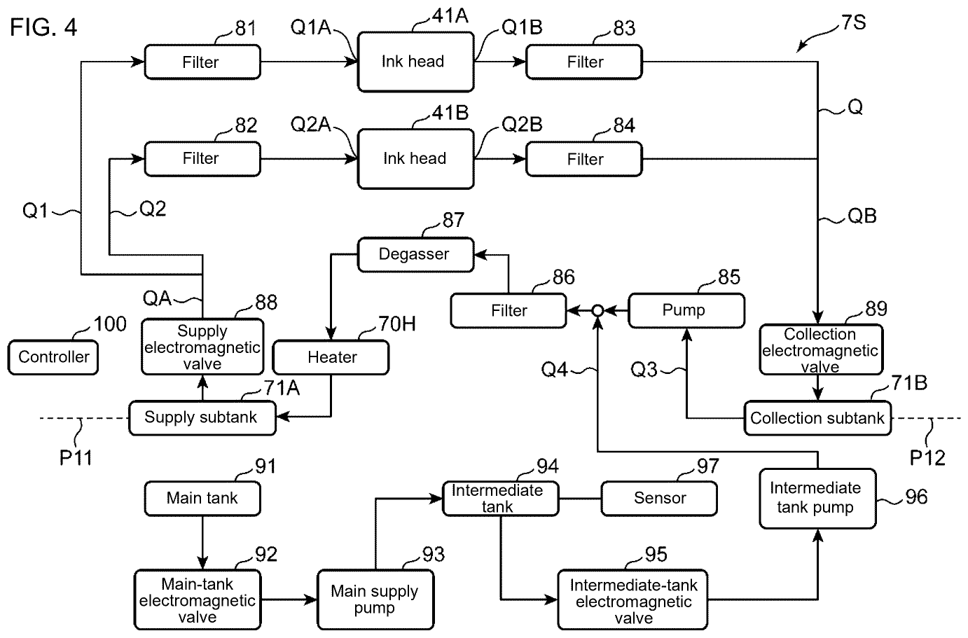

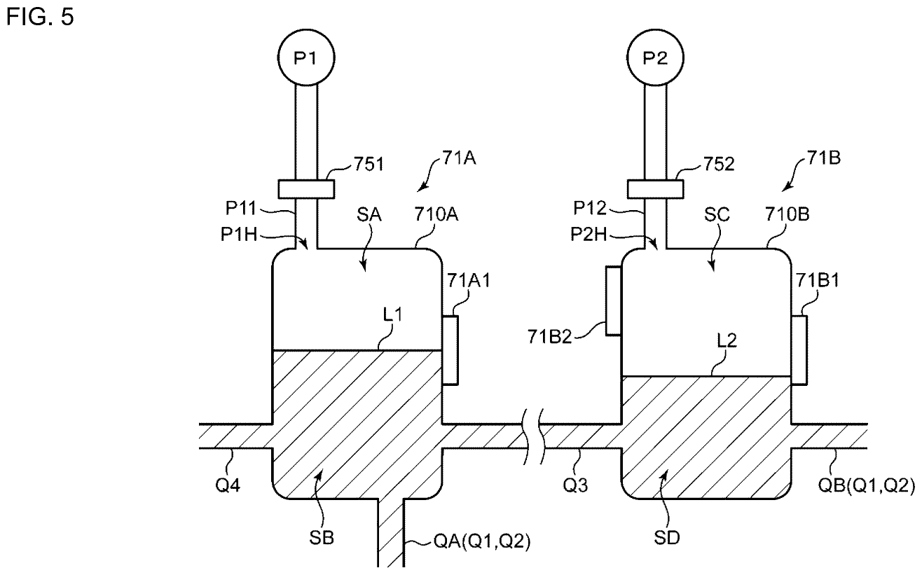

The flow of the ink and the treatment liquids in the inkjet printer 1 according to the present embodiment will now be described. Note that, although the flow of ink is described in detail below, the same or a similar structure is used for each of the treatment liquids. FIG. 4 is a schematic diagram illustrating the flow of ink near liquid ejection heads in the present embodiment. FIG. 5 is a schematic diagram of a supply subtank and a collection subtank according to the present embodiment. Note that, in each of the figures, the lines connecting the components indicate pipes (tubes) for carrying a gas or a liquid.

In the present embodiment, a pressure is applied, with gas (air), to each of the first supply subtank 71 A to the post-treatment supply subtank 7RA (each also referred to as a supply tank) and the first collection subtank 71B to the post-treatment collection subtank 7RB (each also referred to as a collection tank) mounted on the carriage 3 in FIG. 3. This produces a difference in pressure (pressure difference) that causes a liquid (the ink, the pretreatment liquid, or the post-treatment liquid) to be supplied from each of the supply subtanks to the corresponding ink head 4, the pretreatment liquid head 5, or the post-treatment liquid head 6. The difference in pressure also causes the liquid to be collected into each of the collection subtanks from the corresponding head. In other words, a circulation channel is formed for each of the liquids. Note that, when the liquid is circulated between a head and a tank (subtank) using the difference in pressure between the head and the tank to generate a flow of the liquid, air may enter the tank and prevent accurate detection of the amount of the liquid in the tank. One or more aspects of the present disclosure are directed to responding to this issue.

A circulation channel including supply and collection paths of yellow ink to and from the first upstream ink head 41A and the first downstream ink head 41B will be described with reference to FIG. 4. Note that the same or a similar structure as in FIG. 4 is included in the ink heads for other colors. Each of the first upstream ink head 41A and the first downstream ink head 41B (ejection heads) corresponds to the liquid functional component in the present embodiment configured to perform a predetermined function for ink (liquid). The predetermined function is ejection of the ink onto the workpiece W.

The inkjet printer 1 further includes, on the carriage 3, filters 81, 82, 83, and 84, a circulation pump 85 (pump), a filter 86, a degasser 87, a supply electromagnetic valve 88, and a collection electromagnetic valve 89. The inkjet printer 1 further includes, outside the carriage 3 and on the apparatus frame 10 (FIG. 1), the main tank 91, a main-tank electromagnetic valve 92, a main supply pump 93, an intermediate tank 94, an intermediate-tank electromagnetic valve 95, an intermediate tank pump 96, a sensor 97, and a controller 100.

Yellow ink flowing from the first supply subtank 71A into an ink supply channel QA through the supply electromagnetic valve 88 splits into a first ink path Q1 extending through the first upstream ink head 41A and a second ink path Q2 extending through the first downstream ink head 41B. The first upstream ink head 41A is connected to a supply port Q1A and a collection port Q1B in the first ink path Q1, and the first downstream ink head 41B is connected to a supply port Q2A and a collection port Q2B in the second ink path Q2 (refer to FIGS. 6 and 7).

The filter 81 is located upstream from the first upstream ink head 41A, and the filter 82 is located upstream from the first downstream ink head 41B. The filter 83 is located downstream from the first upstream ink head 41A, and the filter 84 is located downstream from the first downstream ink head 41B. These filters remove, for example, foreign substances or dust in ink. After the first upstream ink head 41A and the first downstream ink head 41B eject part of the yellow ink onto the workpiece W, the remaining ink is collected into the first collection subtank 71B through an ink collection channel QB and the collection electromagnetic valve 89. The collected yellow ink is then supplied, by the circulation pump 85, to the first supply subtank 71A through an ink return channel Q3.

The circulation pump 85 is a part of a circulation channel for yellow ink extending from the first supply subtank 71A and back to the first supply subtank 71A through the first upstream ink head 41A, the first downstream ink head 41B, and the first collection subtank 71B as illustrated in FIG. 4. In the present embodiment, the circulation pump 85 pumps yellow ink from the first collection subtank 71B to the first supply subtank 71A.

The filter 86 removes foreign substances in ink to be supplied from the first collection subtank 71B to the first supply subtank 71A. The degasser 87 degasses ink (remove air bubbles) in the ink return channel Q3. A heater 70H heats ink before the ink is supplied to the first supply subtank 71A. In the present embodiment, the heater 70H includes an ink channel (not illustrated) and a heater adjacent to the ink channel. The ink to be supplied to the first supply subtank 71A is maintained at a temperature higher than or equal to a predetermined temperature. This maintains the temperature and viscosity of the ink flowing into the first upstream ink head 41A and the first downstream ink head 41B, thus maintaining stable performance for ink ejection from each of the heads.

Note that the supply electromagnetic valve 88 and the collection electromagnetic valve 89 are opened to respectively open the ink supply channel QA and the ink collection channel QB during normal printing.

The main tank 91 is mounted on the apparatus frame 10 in the inkjet printer 1 and stores yellow ink. Note that the same or similar main tanks 91 are also provided for other colors. The main-tank electromagnetic valve 92 is opened or closed to switch opening and closing of the channel from the main tank 91 to the intermediate tank 94. The main supply pump 93 operates to supply ink from the main tank 91 to the intermediate tank 94.

The intermediate tank 94 stores the yellow ink supplied from the main tank 91. The intermediate-tank electromagnetic valve 95 is opened or closed to switch opening and closing of an ink refill channel Q4 extending from the intermediate tank 94 and merging into the ink return channel Q3. The intermediate tank pump 96 operates to supply ink from the intermediate tank 94 to the first supply subtank 71A. The sensor 97 detects the amount of yellow ink remaining in the intermediate tank 94. Note that the main supply pump 93 operates to refill the intermediate tank 94 with ink supplied from the main tank 91 based on the detection results obtained by the sensor 97 indicating that the amount of ink in the intermediate tank 94 has fallen below a predetermined threshold. In contrast, the intermediate tank pump 96 operates to supply ink from the intermediate tank 94 to the first supply subtank 71 A based on the detection results obtained by a capacitive sensor 71A1 and a capacitive sensor 71B1 (described later).

The controller 100 centrally controls the operation of the inkjet printer 1, and electrically controls each of the components illustrated in FIG. 4.

In one example as illustrated in FIG. 5, the first supply subtank 71A including a box-like tank body 710A stores yellow ink (liquid) with a supply-tank gas area SA and a supply-tank ink area SB defined inside. The supply-tank gas area SA is a space above a level L1 of the yellow ink in the first supply subtank 71A, and the supply-tank ink area SB is an area defined with the yellow ink. The supply-tank gas area SA communicates with a supply pressure channel P11. The supply pressure channel P11 communicates with a first pressure source P1 to regulate the pressure in the supply-tank gas area SA in the first supply subtank 71A and maintain a predetermined pressure. The supply pressure channel P11 includes a supply pneumatic coupling 751 (described later). The supply-tank ink area SB communicates with each of the ink supply channel QA (the first ink path Q1 and the second ink path Q2), the ink return channel Q3, and the ink refill channel Q4.

The first supply subtank 71A includes the capacitive sensor 71A1 (liquid detector) that can detect the level of yellow ink (the amount of ink) in the first supply subtank 71A.

In the same or a similar manner, the first collection subtank 71B including a box-like tank body 710B stores yellow ink with a collection-tank gas area SC and a collection-tank ink area SD defined inside. The collection-tank gas area SC is a space above a level L2 of the yellow ink in the first collection subtank 71B, and the collection-tank ink area SD is an area defined with the yellow ink. The collection-tank gas area SC communicates with a collection pressure channel P12. The collection pressure channel P12 communicates with a second pressure source P2 (pressure regulator assembly) to regulate the pressure in the collection-tank gas area SC in the first collection subtank 71B and maintain a predetermined pressure. The collection pressure channel P12 includes a collection pneumatic coupling 752 (described later). The collection-tank ink area SD communicates with each of the ink collection channel QB (the first ink path Q1 and the second ink path Q2) and the ink return channel Q3.

The first collection subtank 71B includes the capacitive sensor 71B1 (liquid detector) that can detect yellow ink in the first collection subtank 71B, and a capacitive sensor 71B2 (bubble detector) that can detect bubbles of yellow ink above the level L2 of the yellow ink. The bubbles of ink correspond to foam or multiple bubbles. Note that the capacitive sensor 71B2 actually detects, based on the capacitance, a small amount of ink (liquid) forming the films of multiple bubbles, rather than the gas in the bubbles.

In the present embodiment, the supply-tank gas area SA in the first supply subtank 71A is maintained at, for example, +2 kPa, and the collection-tank gas area SC in the first collection subtank 71B is maintained at, for example, −15kPa. In this case, the tank body 710B of the first collection subtank 71B has a negative pressure with respect to the first upstream ink head 41A and the first downstream ink head 41B.

This generates a flow of yellow ink from the first supply subtank 71A to the first collection subtank 71B through the ink supply channel QA (the first ink path Q1 and the second ink path Q2), each of the ink heads, and the ink collection channel QB (the first ink path Q1 and the second ink path Q2) in FIG. 4. Note that both the supply-tank gas area SA and the collection-tank gas area SC may be maintained at a positive pressure higher than the atmospheric pressure. Both the supply-tank gas area SA and the collection-tank gas area SC may also be maintained at a negative pressure lower than the atmospheric pressure. The difference in pressure between the supply-tank gas area SA and the collection-tank gas area SC is 5 to 20 kPa. In any case, the first collection subtank 71B has a negative pressure with respect to each of the ink heads.

When the capacitive sensor 71B1 (FIG. 5) detects the level L2 of the ink in the first collection subtank 71B, the controller 100 causes the circulation pump 85 to operate. Part of the yellow ink in the first collection subtank 71B is then supplied to the first supply subtank 71A through the ink return channel Q3. Note that the circulation pump 85 operates independently of whether the inkjet printer 1 is performing or stopping printing.

Additionally, when the controller 100 determines, based on the detection results obtained by the capacitive sensors 71A1 and 71B1, that the amount of yellow ink in both the first supply subtank 71A and the first collection subtank 71B has fallen below a predetermined threshold, the controller 100 opens the intermediate-tank electromagnetic valve 95 and causes the intermediate tank pump 96 to operate to refill the first supply subtank 71A with yellow ink supplied from the intermediate tank 94 through the ink refill channel Q4 and the ink return channel Q3. During this operation, the intermediate-tank electromagnetic valve 95 opens to adjust the maximum refill amount (refilling rate) for the first supply subtank 71A. When the sensor 97 detects an insufficient amount of yellow ink remaining in the intermediate tank 94, the controller 100 opens the main-tank electromagnetic valve 92 and causes the main supply pump 93 to operate to refill the intermediate tank 94 with yellow ink supplied from the main tank 91.

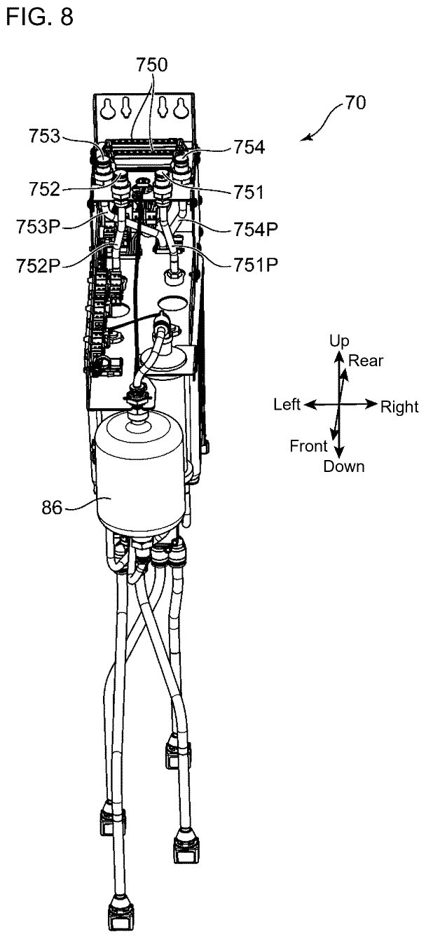

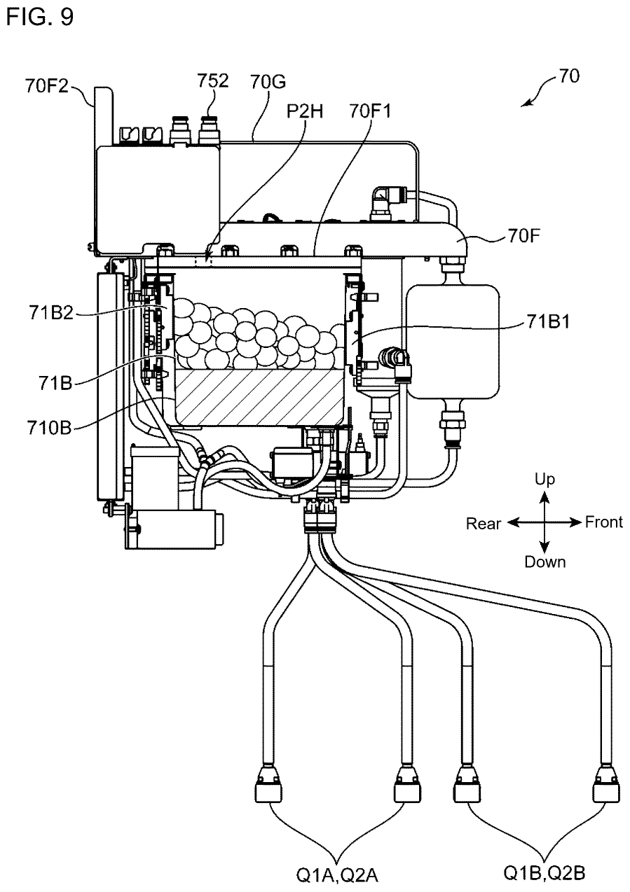

Structure of Tank Unit The structure of each of the subtanks illustrated in FIGS. 3 to 5 will now be described in more detail. FIG. 6 is a perspective view of a tank unit 70 according to the present embodiment of the present disclosure. FIG. 7 is a perspective view of the tank unit 70 as viewed in a direction opposite to the direction in FIG. 6. FIG. 8 is a front perspective view of the tank unit 70. FIG. 9 is a side cross-sectional view of the first collection subtank 71B in the tank unit 70, illustrating ink in its inside.

The tank unit 70 includes the first supply subtank 71A and the first collection subtank 71B, and is attachable to and detachable from the carriage 3 in the inkjet printer 1. The tank unit 70 is provided for each of the colors of ink, the pretreatment liquid, and the post-treatment liquid.

As illustrated in FIGS. 6 and 7, the tank unit 70 includes the first supply subtank 71A, the first collection subtank 71B, the frame 70F supporting these subtanks, the heater 70H described above, the circulation pump 85, the filter 86, the degasser 87, the supply electromagnetic valve 88, and the collection electromagnetic valve 89.

The frame 70F includes a frame horizontal portion 70F1 and a frame rear portion 70F2. The frame horizontal portion 70F1 is a plate extending in a front-rear direction with a predetermined width in the lateral direction.

The frame rear portion 70F2 extends upward from the rear end of the frame horizontal portion 70F1. The first supply subtank 71A and the first collection subtank 71B are supported by the frame 70F to be suspended from the frame horizontal portion 70F1 of the frame 70F. Each of the first supply subtank 71A and the first collection subtank 71B can thus be supported through its upper portion. This structure can leave a space below the tank unit 70, allowing flexible positioning of the first ink path Q1 for supplying ink to the corresponding ink head and the second ink path Q2 for collecting ink from the corresponding ink head.

This structure facilitates supply and collection of ink to and from each of the heads below the corresponding subtank in the carriage 3. The structure also allows effective use of the space in the carriage 3, thus reducing the size of the carriage 3.

The frame 70F includes, above the frame horizontal portion 70F1, a connector 750, the supply pneumatic coupling 751, the collection pneumatic coupling 752, a degasser vacuum coupling 753, and an ink coupling 754 (FIG. 8). The connector 750 is used to supply power to the tank unit 70, and to transmit and receive various signals to and from the tank unit 70. The supply pneumatic coupling 751 is connected to the first pressure source P1 to set the supply-tank gas area SA in the first supply subtank 71A (FIG. 5) to a predetermined pressure. In the same or a similar manner, the collection pneumatic coupling 752 is connected to the second pressure source P2 to set the collection-tank gas area SC in the first collection subtank 71B (FIG. 5) to a predetermined pressure. Note that the first pressure source P1 functions as a pressure regulator that regulates the pressure in the tank body 710A, and the second pressure source P2 functions as a pressure regulator that regulates the pressure in the tank body 710B. The first pressure source P1 and the second pressure source P2 may share the same pressure source, and the pressure supply channels may be switched by, for example, an open-close valve.

The degasser vacuum coupling 753 is connected to a pressure path for evacuating the degasser 87. The ink coupling 754 is connected to the ink refill channel Q4 in FIG. 4.

Referring to FIG. 9, the tank body 710B includes a connection hole P2H (FIG. 5) in its upper surface. In other words, the connection hole P2H is located above the liquid level in the tank body 710B. The connection hole P2H communicates with the collection pneumatic coupling 752 with a tube (not illustrated). More specifically, the internal space of the tank body 710B communicates with the second pressure source P2 (FIG. 5) through the connection hole P2H and the collection pneumatic coupling 752.

As illustrated in FIG. 9, the capacitive sensor 71B2 that detects bubbles is located above the capacitive sensor 71B1 that detects a liquid (liquid level). More specifically, the lower end of the capacitive sensor 71B2 is located above the lower end of the capacitive sensor 71B1. Note that the vertical center of the capacitive sensor 71B2 may be located above the vertical center of the capacitive sensor 71B1.

In the present embodiment, the first supply subtank 71A and the first collection subtank 71B are supported by the frame 70F, and the frame 70F is held by the back frame 32 in the carriage 3 (FIG. 2) in a cantilevered manner. More specifically, as illustrated in FIG. 6, the frame rear portion 70F2 of the frame 70F includes multiple threaded holes 70F3 and 70F4 in its upper end portion. An operator holds a grip 70G in the tank unit 70 and places the frame rear portion 70F2 of the frame 70F in the tank unit 70 in close contact with the back frame 32. The operator then places screws (not illustrated) into the threaded holes described above to fasten the frame rear portion 70F2 to the back frame 32. The frame rear portion 70F2 includes a protrusion 70F5 below the threaded holes described above. The protrusion 70F5 is placed in a hole (not illustrated) in the back frame 32 in the carriage 3. This structure avoids lateral rotation of the tank unit 70 when the carriage 3 is impacted while moving in the main scanning direction S. With such rotation being avoided, a change in the ink level in the tank resulting from the impact is less likely to occur, thus stably maintaining the detection accuracy of each of the capacitive sensors.

As illustrated in FIG. 7, the capacitive sensor 71B2 is closer to the frame rear portion 70F2 than the capacitive sensor 71B1. With the tank unit 70 held in a cantilevered manner as described above, the distal end (front) of the tank unit 70 may be lowered under gravity. However, with the capacitive sensor 71B2 located adjacent to the frame rear portion 70F2, the two sensors, or the capacitive sensors 71B1 and 71B2, are less likely to be located in a physically reversed manner, or to perform detection in a reversed order.

In the present embodiment, for higher maintainability and viewability, the carriage 3 in FIG. 1 includes the subtanks 7 including the multiple tank units 70 (FIG. 6) aligned laterally as viewed from the front of the carriage 3. This allows the multiple tank units 70 to have the same height. As described above, each of the tank units 70 is held in a cantilevered manner by the back frame 32 in the carriage 3 at the rear of the tank unit 70. In this structure, the tank unit 70 is to have a smaller width, with reduced erroneous detection of each of the capacitive sensors. In the present embodiment, each of the capacitive sensors is located at the front or rear of the corresponding tank body 710A or 710B. For the first collection subtank 71B, in particular, the capacitive sensor 71B1 is closer to the back frame 32 than the capacitive sensor 71B2. For the first supply subtank 71 A illustrated in FIG. 6, the capacitive sensor 71A1 is closer to the back frame 32, with no sensor located at the front of the first supply subtank 71A, to allow the ink in the tank to be easily viewable from the front of the inkjet printer 1. A user or the operator of the inkjet printer 1 can thus easily view the amount of ink in the first supply subtank 71A by removing a front cover (not illustrated) of the carriage 3.

As described above, in the present embodiment, the first collection subtank 71B includes the tank body 710B that stores ink and the capacitive sensor 71B2 that detects bubbles of the ink above the ink level in the tank body 710B. The tank body 710B communicates with the corresponding ink head configured to eject ink. The tank body 710B has a negative pressure with respect to the ink head.

In this structure, the capacitive sensor 71B2 can detect bubbles of ink filling the tank body 710B having a negative pressure with respect to the ink head. This operation of the inkjet printer 1 can thus be stopped as appropriate for maintenance. This reduces the likelihood that the bubbles degrade the performance of ink supply or ink collection for the corresponding ink head.

In the present embodiment, the capacitive sensor 71B2 is used as a sensor that detects bubbles in the tank body 710B. The capacitive sensor 71B2, which detects the capacitance of the liquid forming the films of bubbles, can accurately detect bubbles in the tank body 710B. Note that the sensor that detects bubbles is not limited to a capacitive sensor, and may be a float switch including a magnetoresistive sensor (non-contact) or a reed switch (contact). However, the capacitive sensor with relatively high accuracy in detecting bubbles may be used.

In the present embodiment, the first collection subtank 71B further includes the capacitive sensor 71B1 that detects ink in the tank body 710B. The capacitive sensor 71B2 is located above the capacitive sensor 71B1. In this structure, the capacitive sensor 71B1 can detect the amount of ink in response to rise or fall of the ink level in the tank body 710B. In contrast, the capacitive sensor 71B2 located above the capacitive sensor 71B1 can stably detect bubbles of ink in the tank body 710B.

In the present embodiment, the tank body 710B includes the connection hole P2H. The connection hole P2H is connected to the tank body 710B above the ink level and communicates with the second pressure source P2 that regulates the pressure in the tank body 710B. In this structure, bubbles of ink filling the tank body 710B may enter the second pressure source P2 through the connection hole P2H, possibly damaging various components of the second pressure source P2, such as an electromagnetic valve and a pressure sensor. In the present embodiment, however, the capacitive sensor 71B2 can detect bubbles of ink in the tank body 710B, and the detection results can be indicated through, for example, a display (not illustrated) in the inkjet printer 1. This can safely reduce damage to the second pressure source P2 described above. In response to the detection results, the collection electromagnetic valve 89 can be closed to prevent an increase in bubbles of ink in the tank body 710B caused by gas entering the tank body 710B. This can further reduce the likelihood of bubbles entering the connection hole P2H.

In the present embodiment, the inkjet printer 1 further includes a liquid circulation device 7S as illustrated in FIG. 4. The liquid circulation device 7S includes the corresponding ink head, the first supply subtank 71A communicating with the ink head upstream from the ink head, the first collection subtank 71B communicating with the ink head downstream from the ink head, and a circulation channel Q. The circulation channel Q extends from the first supply subtank 71A and back to the first supply subtank 71 A through the corresponding ink head and the first collection subtank 71B. The first collection subtank 71B has a negative pressure with respect to the first supply subtank 71A. This structure can collect excess ink from the corresponding ink head while supplying ink to the ink head, allowing circulation of ink. This allows efficient use of ink without waste, and can also avoid ink stagnation in a specific area, thus stably maintaining the characteristics of ink. With the capacitive sensor 71B2 included in the first collection subtank 71B to detect bubbles of ink, the circulating ink is less likely to contain many bubbles.

In the present embodiment, in particular, the liquid circulation device 7S uses ink as a liquid to be circulated. Each of the ink heads is an ejection head configured to eject ink onto the workpiece W as a predetermined object. This structure can also circulate ink and detect bubbles, thus maintaining stable performance for ink ejection from each of the ink heads. Note that the liquid circulated by the liquid circulation device 7S is not limited to ink, and may be one of the pretreatment liquid or the post-treatment liquid.

In the present embodiment, the first pressure source P1 applies pressure through the first supply subtank 71A to the corresponding ink head, and the second pressure source P2 applies suction through the first collection subtank 71B to the corresponding ink head. This regulates the pressure applied to the corresponding ink head and generates a flow of ink throughout the circulation channel Q. However, when the pressure applied through the first supply subtank 71A is reduced, for example, air may flow in through the nozzles of the ink head with the suction (or vacuuming) caused by the negative pressure in the first collection subtank 71B. Such air then flows into the first collection subtank 71B and forms bubbles of ink. The first collection subtank 71B including the capacitive sensor 71B2 can effectively detect such unexpected occurrence of bubbles. Note that such suction of bubbles can occur in the first collection subtank 71B but is less likely to occur in the first supply subtank 71A. In the present embodiment, the first collection subtank 71B thus includes the capacitive sensor 71B2, and the first supply subtank 71A includes no sensor that detects bubbles. This reduces the cost of the tank unit 70.

Note that air that may form bubbles in the first collection subtank 71B can enter through cracks in the channel extending from the first supply subtank 71A to the first collection subtank 71B including ink heads, or through gaps between components on the channel. However, the structure in the present embodiment can reduce or avoid such entrance of air.

In the present embodiment, the inkjet printer 1 includes the liquid circulation device 7S described above and the workpiece feeder 20 (support) that supports the workpiece W to cause the workpiece W to face each of the ink heads. The inkjet printer 1 can perform recording on the workpiece W with a liquid such as ink ejected from the ink head. The recording refers to applying (or fixing) the ejected liquid onto the workpiece W or resulting formation of, for example, an image on the workpiece W. This structure can detect bubbles in the circulation channel Q, in addition to ejecting a liquid such as ink, thus achieving stable printing and recording on the workpiece W.

Note that the liquid circulation device 7S illustrated in FIG. 4 and the tank unit 70 illustrated in FIGS. 6 to 9 can also be used to supply, eject, and collect the pretreatment liquid and the post-treatment liquid as well as the ink, as described above. In the present embodiment, the pretreatment liquid contains many ionic compounds (salts) and thus has a high dielectric constant, which tends to increase the capacitance. Thus, the capacitive sensor 71B1 and the capacitive sensor 71B2 have lower sensitivities in the liquid circulation device 7S (first liquid circulation device) that circulates the pretreatment liquid than in the liquid circulation device 7S (second liquid circulation device) that circulates the ink or the post-treatment liquid. This reduces the likelihood that the level of the pretreatment liquid is too low as compared with the levels of the ink and the post-treatment liquid in the corresponding subtanks, and reduces the likelihood that no pretreatment liquid is left in the tank body 710B. Note that a higher predetermined threshold may be used instead of a lower sensitivity described above. In this case, liquids or bubbles are detected in portions facing the sensors in response to the capacitances of the liquids or the bubbles exceeding the corresponding thresholds. Thus, setting a higher threshold corresponds to setting a lower sensitivity.

Note that the relationship of sensitivity between the first and second liquid circulation devices 7S described above is the same as or similar to the relationship of sensitivity between the first collection subtank 71B for the pretreatment liquid and the first collection subtank 71B for the ink or the post-treatment liquid. These multiple first collection subtanks 71B form a collection subtank group (liquid storage tank group) included in the inkjet printer 1.

The present disclosure is not limited to the above embodiments and may be implemented in the following forms.
(1) The ink heads 4 are not limited to those arranged in two arrays on the carriage 3. The ink heads 4 may be in a single array or in three or more arrays. The inkjet printer 1 is not limited to a printer configured to eject multiple colors of ink onto the workpiece W, and may be configured to eject a single color of ink. In the inkjet printer 1, the workpiece W may be supported at a predetermined print position, and the multiple heads held by the carriage 3 may eject liquids while moving in the main scanning direction and the subscanning direction.
(2) In the above embodiments, the inkjet printer 1 may eliminate the pretreatment liquid head 5 that ejects the pretreatment liquid, the post-treatment liquid head 6 that ejects the post-treatment liquid, and any components associated with these heads.
(3) The multiple structures described in the above respective embodiments may be combined with one another to provide an embodiment of the present disclosure. In one example, the first collection subtank 71B (liquid storage tank) and the first upstream ink head 41A (liquid functional component) form a liquid functional unit. The liquid functional unit may further include the first downstream ink head 41B or the first supply subtank 71A. The first collection subtank 71B allows detection of bubbles of a liquid such as ink, and thus the first upstream ink head 41A can stably eject the liquid. Note that the liquid functional component may have any function other than ejecting a liquid. The liquid functional component may be, for example, a final storage for ink located upstream from the corresponding ink head. In this case, the liquid functional component is configured to finally store the ink. In this structure as well, the first collection subtank 71B allows detection of bubbles of a liquid such as ink, and thus the liquid functional component can stably store the liquid without being affected by bubbles.

The first collection subtank 71B (liquid storage tank) and the second pressure source P2 (pressure regulator) form a liquid storage unit. The liquid storage unit may further include the first downstream ink head 41B or the first supply subtank 71A. The first collection subtank 71B allows detection of bubbles of a liquid such as ink, and thus the second pressure source P2 is less likely to be damaged. The second pressure source P2 can thus stably regulate the pressure in the first collection subtank 71B.

### REFERENCE SIGNS

inkjet printer (recording apparatus)
carriage
ink head (ejection head, liquid functional component)
41 Afirst upstream ink head
41B first downstream ink head
pretreatment liquid head
post-treatment liquid head
subtank
70 tank unit
70F frame
70F1 frame horizontal portion
70F2 frame rear portion
70H heater
710A, 710B tank body
71 Afirst supply subtank (supply tank)
71A1 capacitive sensor
71B first collection subtank (liquid storage tank)
71B1 capacitive sensor (liquid detector)
71B2 capacitive sensor (bubble detector)
7S liquid circulation device
L1, L2 level
P1 first pressure source
P1H connection hole
P11 supply pressure channel
P12 collection pressure channel
P2 second pressure source
P2H connection hole
Q circulation channel
QA ink supply channel
QB ink collection channel
Q1 first ink path
Q2 second ink path
Q3 ink return channel
Q4 ink refill channel

1. A liquid storage tank, comprising:
a tank body configured to store a liquid; and
a bubble detector configured to detect bubbles of the liquid above a level of the liquid in the tank body,
wherein the tank body communicates with a liquid functional component configured to perform a predetermined function for the liquid, and the tank body has a negative pressure with respect to the liquid functional component.

2. The liquid storage tank according to claim 1, wherein
the bubble detector includes a capacitive sensor.

3. The liquid storage tank according to claim 1, further comprising: a liquid detector configured to detect the liquid in the tank body,
wherein the bubble detector is located above the liquid detector.

4. The liquid storage tank according to claim 1, further comprising:
a connection hole connected to the tank body above the level of the liquid, the connection hole communicating with a pressure regulator configured to regulate a pressure in the tank body.

5. A liquid circulation device, comprising:
the liquid storage tank according to claim 3;
the liquid functional component;
a supply tank communicating with the liquid functional component upstream from the liquid functional component; and
a circulation channel extending from the supply tank and back to the supply tank through the liquid functional component and the liquid storage tank,
wherein the liquid storage tank has a negative pressure with respect to the supply tank.

6. The liquid circulation device according to claim 5, wherein
the liquid is one of ink, a pretreatment liquid, or a post-treatment liquid, and
the liquid functional component is an ejection head configured to eject the liquid onto a predetermined object.

7. A recording apparatus, comprising:
the liquid circulation device according to claim 6; and
a support configured to support the object to cause the object to face the ejection head,
wherein the recording apparatus is configured to perform recording on the object with the liquid ejected from the ejection head.

8. The recording apparatus according to claim 7, wherein
the recording apparatus includes a plurality of the liquid circulation devices,
the plurality of liquid circulation devices includes a first liquid circulation device configured to circulate the pretreatment liquid and a second liquid circulation device configured to circulate the ink or the post-treatment liquid, and
the bubble detector in the first liquid circulation device has a lower sensitivity than the bubble detector in the second liquid circulation device.

9. The recording apparatus according to claim 8, wherein
the liquid detector in the first liquid circulation device has a lower sensitivity than the liquid detector in the second liquid circulation device.

10. A liquid storage tank group, comprising:
a plurality of the liquid storage tanks according to claim 1,
wherein the plurality of liquid storage tanks includes a first liquid storage tank configured to store a pretreatment liquid and a second liquid storage tank configured to store ink or a post-treatment liquid, and
the bubble detector in the first liquid storage tank has a lower sensitivity than the bubble detector in the second liquid storage tank.

11. The liquid storage tank group according to claim 10, wherein
each of the plurality of liquid storage tanks further includes a liquid detector configured to detect the liquid in the tank body, and
the liquid detector in the first liquid storage tank has a lower sensitivity than the liquid detector in the second liquid storage tank.
